(19) United States
(12) Patent Application Publication
(10) Pub. No.: US 2008/0120511 A1
(43) Pub. Date: May 22, 2008

(54) APPARATUS, AND ASSOCIATED METHOD, FOR PROVIDING SECURE DATA ENTRY OF CONFIDENTIAL INFORMATION

(75) Inventor: NAYER NABIL NAGUIB, CAIRO (EG)

Correspondence Address: DOCKET CLERK, P.O. BOX 12608, DALLAS, TX, 75225, US

(73) Assignee: ELECTRONIC DATA SYSTEMS CORPORATION, PLANO, TX (US)

(21) Appl. No.: 11/935,177

(22) Filed: Nov. 5, 2007

Related U.S. Application Data
(60) Provisional application No. 60/859,545, filed on Nov. 17, 2006.

(51) Int. Cl. H04L 9/00; G06F 12/14

(52) U.S. Cl. 713/194; 726/30

(57) ABSTRACT

A hardware token, and an associated methodology, that converts confidential input information into secure form prior to its input to a computing station, such as a desktop or laptop computer. The hardware token is positioned in line between an input keyboard or keypad and the computer. All confidential information is converted into secure form, such as by encryption by an encryption key retrieved from a memory location of the hardware token.

### CROSS REFERENCE TO RELATED APPLICATIONS

The present invention claims the priority of provisional patent application 60/859,545, filed Nov. 17, 2006, the entire contents of which are incorporated herein by reference.

The present invention relates generally to a manner by which to provide for secured communications, such as communications between a computing station and a remote station that require end-to-end security. More particularly, the present invention relates to an apparatus, and an associated method, by which to encrypt, or otherwise secure, data prior to its input to the computing station.

Security problems that might occur as a result of improper access to secure information are avoided as the data is encrypted prior to its input into the computing station. An external, hardware token is positioned in-line with a computer keyboard or keypad. The hardware token receives user-generated inputs entered by way of the keyboard or keypad. The hardware token encrypts, or otherwise secures, the input information prior to its input to the computing station.

### BACKGROUND OF THE INVENTION

Technological innovation has brought about significant changes in modern society. For many, the ready availability and access to low-cost, personal computer, and other processor-based devices to perform many varied functions and services is needed to carry out daily activities. Through interconnection of the personal computers by way of network connections, such as the Internet, communications between disparately-positioned computers is possible. A communication service, including a communication service for which communication security is required, is regularly carried out by way of Internet-connected personal computers.

Due to the public nature of the Internet, security of communications can only be assured by securing the data, such as by encrypting the data, prior to its communication upon the public network. The informational content of the data, once encrypted or otherwise secured, cannot be ascertained by any party that does not have access to the manner by which the data was secured or encrypted.

Many communication services have security requirements that must be met in order for the service to proceed. Internet banking and e-government systems are exemplary of services and systems that require adequate levels of security to be attained to permit the communication service to be carried out properly. In such services and systems, a user of a personal computer is able to access a system server by way of the Internet to carry out a banking or e-government service.

In a typical security scheme, an e-signature solution is implemented. A user electronically signs transaction information through use of a unique encryption key. The encryption key is sometimes stored on a hardware token that is provided to the user. In order to sign the transaction details and enter confidential information, the user should have a secure manner by which to enter the details to the hardware token so that the correct transaction is properly signed, and the confidential information is not stolen or improperly accessed by means of malicious software. The user also must ensure that the legitimate transaction is being signed by the token and that there is no possibility of a fraudulent transaction being sent to the token.

Various e-signature hardware tokens are available. Various of such tokens contain built-in input and output devices. The input and output devices are provided for a user securely to enter confidential information but without exposing the information to malicious software that might be resident at the computing station. Output devices are provided to the token, e.g., to permit the user to view the output of the transaction encryption process. The user is able thereby to copy the encryption result that might be needed to complete a web-based form of a communication service provider.

Such existing hardware tokens that contain the built-in and output devices are, however, relatively bulky, being of relatively large size due to the input and output devices. Additionally, some of such hardware tokens utilize smart card readers and their use further increases the cost of the hardware token.

Existing hardware tokens that include the input and output devices to ensure that computer-resident, malicious software does not defeat the confidentiality of the input information exhibit size and cost disadvantages. An improved hardware token that is less bulky and is less costly would therefore be advantageous.

It is in light of this background information related to the secure communication of data that the significant improvements of the present invention have evolved.

### SUMMARY OF THE INVENTION

The present invention, accordingly, advantageously provides apparatus, and an associated method, for providing for secure communications, such as communications between a personal computer and a remote server in which end-to-end security is provided.

Through operation of an embodiment of the present invention, a manner provided by which to encrypt, or to otherwise secure, data prior to its input to the personal computer, or other computing station.

Because the data is secured prior to input to the computing stations, security-related problems that might otherwise occur as a result of operation of malicious software resident at the computing station is avoided.

In one aspect of the present invention, an external hardware token is provided that is connected to a personal computer, or other computing station. The external hardware token stores an encryption key or other security element. When end-to-end security is required pursuant to a communication service, the hardware token encrypts, or otherwise places in secure form, input information needed pursuant to the service. By converting the input information into secure form, its content can not be ascertained by an unauthorized entity. Confidential input information, such as a user's PIN (Personal Information Number), credit card number, etc. are converted into secure form. Once encrypted or otherwise secured, the information is input into the personal computer or other computing device. Because the information is secured prior to input to the computing device, malicious software that might be resident at the computing device is unable to ascertain or use the information.

In another aspect of the present invention, the hardware token is used in conjunction with a desktop computer that includes an external keypad, connectable to the personal computer in conventional manner, such as by way of a USB (Universal Serial Bus) or serial connection. The hardware token is positioned in-line between the external keyboard and the personal computer. A user of the personal computer enters input information by way of the external keyboard. And, the hardware token operates to place the input information in secure form. Once placed in the secure form, the encrypted or otherwise secured information is input to the personal computer by way of the same input port at which the keyboard would otherwise be connected.

In another aspect of the present invention, the hardware token is used in conjunction with a laptop computer or other computer station that uses an integrated keyboard. The hardware token is combined with a keypad, such as an inexpensive, numeric keypad. User-input information, input by way of the keypad is encrypted or otherwise placed in secure form through operation of the hardware token. And, once placed in secure form, the information is provided to the computer. Again, because the hardware token carries out its operations external to the computing station, the malicious software, if resident at the computing station, is unable to ascertain values of, or maliciously utilize, the input information.

In another aspect of the present invention, multiple encryption keys are maintained at the hardware token. Selection is made, such as by user selection, of which of the encryption keys to utilize to encrypt or place into secure form the input information. When user-selection is made, selection is made, for instance, by way of the input keyboard or keypad. Selection is made, for instance, pursuant to selection of a secured communication service to be performed. The selected encryption key is used to encrypt the input information to place the information in encrypted or secure form prior to its input into the computing station.

In another aspect of the present invention, the hardware token is placed in to, or taken out of, connection with the computing station without need to reboot the computing station. That is to say, the hardware token is hot-pluggable in to, and out of, connection with the computing station. The hardware token is thereby positionable to provide operation with minimal disruption to ongoing computing station operations. The use of the hardware token is transparent. That is to say, the token, when used, does not alter normal operation of the computing station. And, the user of the computing station need not alter normal input procedures by way of which a user normally enters input information.

In another aspect of the present invention, the hardware token, when positioned in the in-line, daisy-chain connection between the input keyboard or keypad and the computing station, is configured alternately in an active mode and in an inactive mode. When configured in the inactive mode, the token is completely transparent to both the computing station to which the token is connected and to a user of the computing station. When configured in the active mode, the hardware token operates as a firewall between the input keyboard or keypad and the computing station. Input information entered by way of the keyboard or keypad is blocked by the token and is prevented from being provided to the computing station. When selected secret information is entered by way of the keyboard or keypad, the hardware token generates an encrypted form of the data and provides the encrypted form of the data to the computing station as if the encrypted form of the information were directly entered by way of the keyboard or keypad.

In these and other aspects, therefore, an apparatus, and an associated method, is provided for facilitating entry of confidential information at a secured-communication-service station. A connector is configured to form a connection with an input location of the secured communication service station. A confidential information store is configured to store confidential information. And, a converter is configured to form secure data using the confidential information stored at the confidential information store. The secure data, once formed, is provided to the secure communication service station by way of the connector.

A more complete appreciation of the scope of the present invention and the manner in which it achieves the above-noted and other improvements can be obtained by reference to the following detailed description of presently preferred embodiments taken in connection with the accompanying drawings, which are briefly summarized below, and by reference to the appended claims.

### BRIEF DESCRIPTION OF THE DRAWINGS

FIG. 1 illustrates a functional block diagram of a network-connected configuration of computing stations in which an embodiment of the present invention is operable.

FIG. 2 illustrates a functional block diagram of the apparatus of an embodiment of the present invention.

FIG. 3 illustrates an arrangement including the apparatus of an embodiment of the present invention.

FIG. 4 illustrates another arrangement that also includes an embodiment of the present invention.

FIG. 5 illustrates a process diagram representative of the process of operation of an embodiment of the present invention.

FIG. 6 illustrates a method flow diagram representative of the method of operation of an embodiment of the present invention.

### DETAILED DESCRIPTION

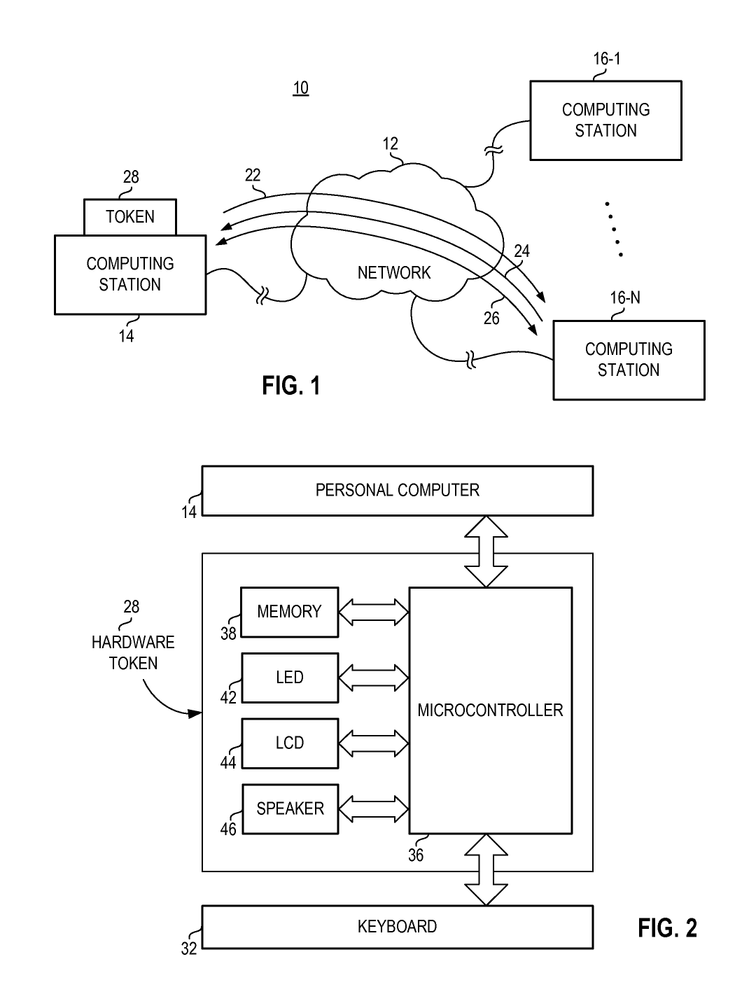

Referring first, therefore, to FIG. 1, a communication system, shown generally at 10, is representative of a communication system that provides for packet-based, or other, communication services. Here, the communication system includes a public-network backbone, the Internet 12, to which communication stations 14 and 16 are connected. While, in the illustration of FIG. 1, only a small number of communication stations 14 and 16 are shown, in an actual system, large numbers of communication stations are connectable to the network backbone.

In the exemplary implementation, the communication station 14 forms a computing station, such as a personal computer, or the like. And, the communication stations 16-1 and 16-N comprise secured server systems, or other computing stations, that operate pursuant to a secured communication service. In a typical arrangement, the entities 16 are configured in manners that limit access to the respective entities. Security firewalls (not shown) and security procedures are utilized to limit the access to the entities 16.

The computing station 14 is here representative of an entity capable of communicating, by way of the backbone 12 and accessing an entity 16 through use of appropriate access procedures. The access is granted by the entity 16 if the computing station 14 is properly authenticated, and, once authenticated, is determined to be otherwise permitted to access the respective entities.

The segments 22 and 24 are representative of an authentication procedure in which, e.g., a public-private key exchange is performed, and an encryption key is utilized at the computing station 14 to encrypt input information that is used to authenticate the computing station. Once authenticated, the computing station 14 is permitted to communicate, indicated by the segment 26, with an entities 16 pursuant to the secured communication service.

The secure communication service comprises, for instance, an internet banking service, an e-government system service, or any of various other services that have strict security requirements, where non-repudiation should be enforced.

The segments 22 and 24 are representative, for instance, of an e-signature solution where transaction information is electronically signed at the computing station 14, and the signed transaction information is communicated to the entity 16. In order securely to sign the transaction information and to enter other confidential information, the secure entry of the information at the computing station 14 is required. If not secure, the information is susceptible to access by malicious software. And the information might subsequently be used pursuant to a fraudulent transaction. That is to say, in the event that the confidential information is accessed by fraudulent software or is otherwise obtained, there is a possibility that a fraudulent transaction might be attempted. As also noted previously, hardware tokens are sometimes utilized. But, existing hardware tokens that include input and output devices are generally bulky and costly.

In accordance with an embodiment of the present invention, a hardware token 28 is provided that permits the entry of confidential information and in a manner that is impervious to attack by malicious software or other hacking efforts. The hardware token is also hot-pluggable in to connection with the computing station 14 without requiring rebooting of the computing station. All input information that needs to be encrypted or otherwise secured is secured prior to its input into the computing station, thereby ensuring that malicious software resident at the computing station is unable to ascertain the input information.

FIG. 2 again illustrates the hardware token 28, here in connection with a personal computer forming the computing station 14. The token is connected, in-line, with a keyboard 32 that is otherwise connectable directly to the personal computer. That is to say, rather than directly connecting the keyboard to the personal computer, such as at a USB port or at a serial port of the personal computer, the keyboard is instead directly connected to the token 28, and, in turn, the hardware token is connected to the USB or serial port of the personal computer. As shall be noted below with respect to FIG. 4, in the event that the personal computer comprises a laptop arrangement, having an integral keyboard, an inexpensive keypad is substituted, in the arrangement shown in FIG. 2, for the keyboard. Input information that is to be input in secure form is entered by way of the inexpensive keypad.

The hardware token, in the exemplary implementation, includes a microcontroller 36 to which a memory element 38 is connected. The memory element, in one implementation, forms part of the microcontroller. The token also includes, in the exemplary implementation, a Light Emitting Diode (LED) 42, a Liquid Crystal Display (LCD) 44 and a speaker 46. The microcontroller is configured to receive input information entered through actuation of an actuation key of the keyboard or keypad. When in an active mode, the microcontroller operates to encrypt the input information input by way of the keyboard or keypad. An encryption key, here stored at the memory 38 and retrieved therefrom, is used to encrypt the input information. Once encrypted, the encrypted information is provided to the personal computer. In other implementations, the hardware token is configured in other manners that operate to convert input information into secure form. In the exemplary implementation, the computing station is not aware of the presence of the token and does not, of itself, issue any command to the token or select an encryption key.

In one implementation, a plurality of encryption keys are stored at the memory 38, each selectably retrievable through operation of the microcontroller. Selection is made, for instance, by a user through user actuation of an actuation key on the keyboard or by way of other input. The appropriate encryption key is retrieved and combined with the input information and then provided to the personal computer. The microcontroller operates as a converter to convert the input information into encrypted form.

The hardware token is used not only for end-to-end secured communications, but also to provide for online transaction processing. By way of an example, online transaction processing is provided to the user (the “transferor”) that elects to transfer monies to a recipient (the “transferee”). The transferor, by way of a computing station such as the computing station 14, connects to a bank web site. The transferor logs-in using a log-in and password in conventional manner, viz., exposed to ordinary software/network attacks. The transfer is requested, together with transfer details, such as the name of the transferee, the amount and the date of the transfer. Confidential information, e.g., an ATM (Automatic Teller Machine) PIN is not, however, entered. The bank website, embodied, e.g., at a computing station 16, asks the transferor to connect to the hardware token, to activate the token, and to select the bank's encryption, to re-enter all of the previously-entered fields, in addition to entry of the transferor's PIN, to start the encryption process, and to instruct the token to form encrypted information. Once formed, and provided to the web-site of the bank, from the bank's point of view, the bank is assured that the transferor is the authentic transferor, due to the unique encryption key that was used to encrypt the correct PIN. And, the bank is certain of the specifics of the instructions. Even if an attacker were to steal the transferor's log-in and password, the transferor remains secured as the attacker would still not have the token and learn of the PIN. Other online transactions, such as e-government services, are analogous.

Hardware-token outputs, are also used, in one implementation, to show menu options, error messages, instructions, etc. to a user by way of, e.g., the display 42 or 44. For example, a user is able to set the focus to a text area on a web form so that, when a token is activated, a welcome message is displayed. Menu options, error messages, etc. are displayable.

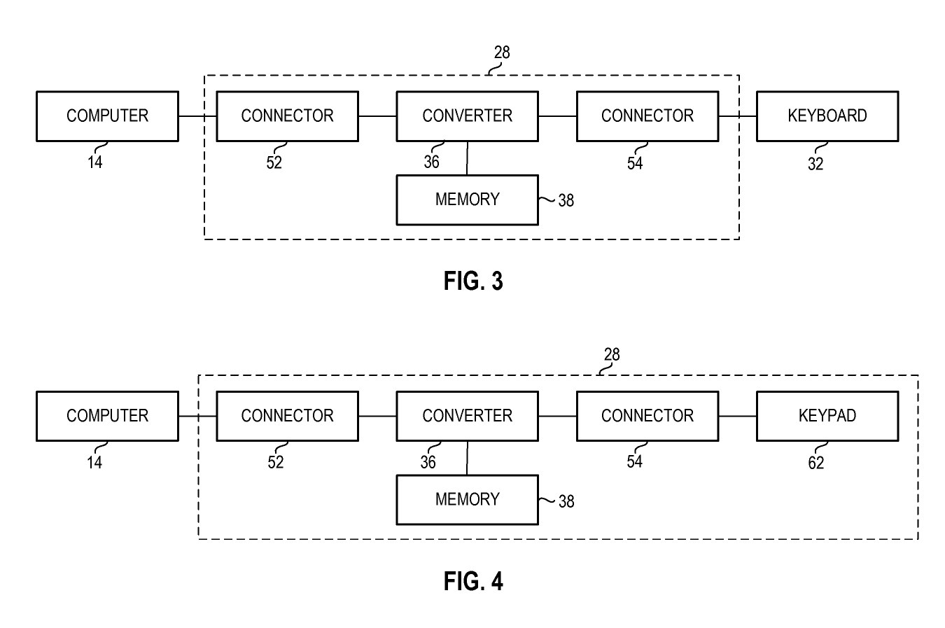

FIG. 3 again illustrates the daisy chain arrangement of positioning of the hardware token 28 in-line between the personal computer that forms the computing station 14 and the external keyboard 32. The hardware token is here shown to include a connector 52 that permits connection of the hardware token to the personal computer. The connector provides, for instance, connection to a USB port of the personal computer, to a serial port of the personal computer, or other connection location. The microcontroller is functionally represented as a converter 36 that is connected to the memory element 38 to permit access to the contents stored thereat. The token further includes a keyboard connector 54 that provides for connection of the keyboard 32 thereto. In the exemplary implementation, the connector 52 provides for the connection of the hardware token to permit its hot-plugging in to and out of connection with the computing station in the same manner in which a keyboard would otherwise be connectable in the hot-plugged connection. As shown, the keyboard 32 connects to the connector 54, and the connector 52 connects to the personal computer.

Input information that is to be sent is to be converted into secure form by the converter 36, here by encrypting the input information with an encryption key retrieved from the memory element. In the exemplary implementation, the converter formed of the microcontroller and the associated elements, such as the memory element 38, are supported at a hardware token housing (not separately shown) in FIG. 2. Power required to operate the hardware token is alternately supplied by way of connection with the personal computer or by portable battery, or other, power supplied at the hardware token or otherwise provided thereto.

FIG. 4 illustrates an arrangement, again including the hardware token 28 of an embodiment of the present invention, positionable in connection with the personal computer 14. In the implementation illustrated in FIG. 4, the token includes a keypad 62 that includes actuation keys that are actuable by a user. The keypad is connected to the converter 36 formed of a microcontroller. The converter is again connected to a memory device 38 and is able to access information, such as encryption keys stored thereat. The hardware token again also includes a connector 52 that provides for connection of the hardware token with an appropriate input port of the personal computer, such as a USB port, serial port, or other connecting port.

While the implementation shown in FIG. 4 is operable in conjunction with any of various types of computing stations, the hardware token of this implementation is particularly amenable for use when the computing station forms a laptop computer or otherwise includes an integrated keyboard. A low-cost keypad 62 provides for the entry of input information by a user of the personal computer while ensuring that the input information is converted into secure form by the converter 36, such as through encryption by an encryptor key retrieved from the memory element 38. Through entry of the input information by way of the keypad rather than the integrated keyboard of the laptop computer, the input information is secured prior to its input to the computing station. Ascertainment of the input information by malicious means, such as by malicious software at the computing station, is prevented.

The hardware token is set alternately to an active or to an inactive mode. When in the active mode, the token acts as a firewall between the keyboard or keypad and the computing station. Input information entered by way of the keyboard or keypad is blocked by the token and is prevented from being input into the computing station. When secret information is entered at the keyboard or keypad, the token generates an encrypted form of the data, and provides the encrypted form of the data to the computing station as if the encrypted information were the information actually entered by way of the keyboard or keypad. Alternately, when set to an inactive mode, the hardware token is completely transparent to both the computer and to the keyboard or keypad and can be removed without the need to restart the computer.

When multiple encryption keys are stored at the memory element 38, an appropriate encryption key is accessed and used, thereby permitting secured operation of the computing station with respect to multiple organizations.

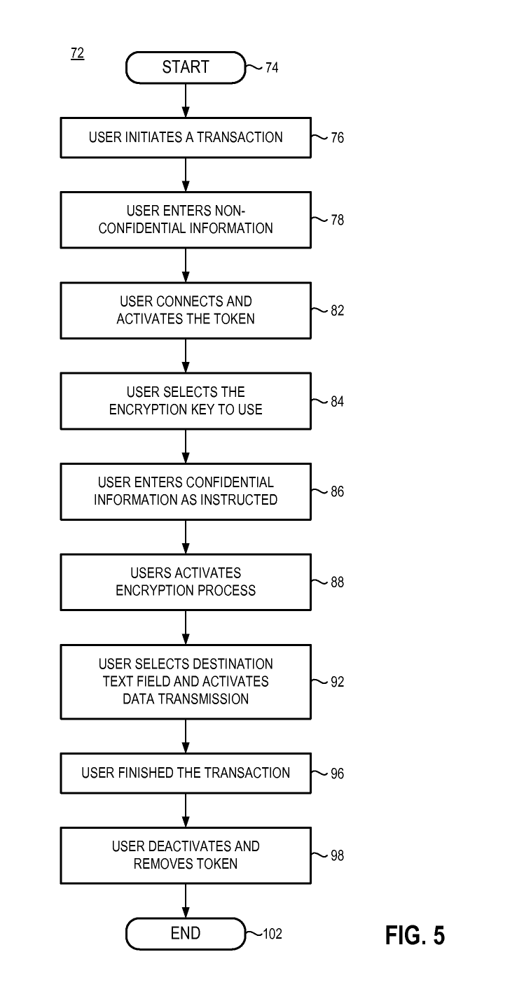

FIG. 5 illustrates a process diagram, shown generally at 72, representative of the process of operation of an embodiment of the present invention. The process facilitates secure input of input information such that the input information is converted into secure form prior to its input into a computing station.

After entry into the process, indicated by the start block 74, a transaction is initiated by a user, indicated by the block 76. Subsequent to initiation, and as indicated by the block 78, a user enters non-confidential information by way of a keyboard or keypad. And, as indicated by the block 82, the user connects and activates the hardware token. The user further selects, indicated by the block 84, the encryption key to utilize by way of which to encrypt the input information.

Then, and as indicated by the block 86, the user enters confidential information, such as instructed pursuant to access to a remote service. And, as indicated by the block 88, the user activates the encryption process at the hardware token.

As indicated by the block 92, the user selects a destination text field and activates data transmission. Then, as indicated by the block 96, the user finishes the transaction and deactivates, and removes, indicated by the block 98, the hardware token. A path is then taken to the end block 102.

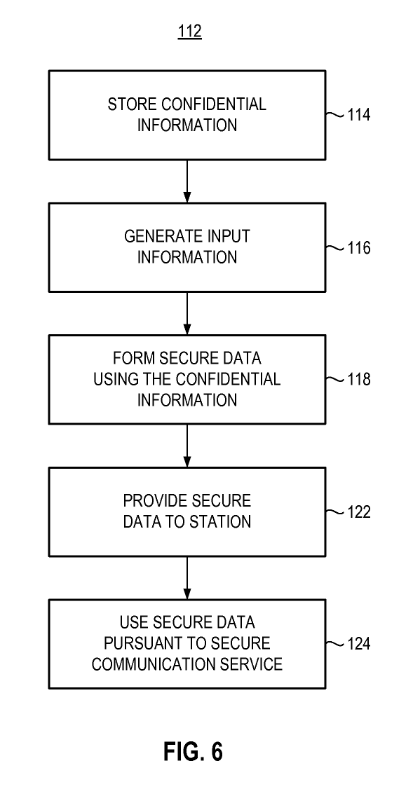

FIG. 6 illustrates a method, shown generally at 112, representative of the method of operation of an embodiment of the present invention. The method 112 facilitates entry of confidential information at a secure-communication-service station.

First, and as indicated by the block 114, confidential information is stored external to the secured-communication-service station. Then, and as indicated by the block 116, input information is generated external to the secure-communication-service station.

Thereafter, and as indicated by the block 118, secured data is formed external to the secure-communication-service station using the stored confidential information. And, as indicated by the block 122, the secure data is provided to the secure-communication-service station. The secure data is utilized, indicated by the block 124, by the secure-communication-service station pursuant to a secure-communication-service.

Use of the hardware token completely eliminates the risk of confidential information being stolen in the presence of malicious software, operating system vulnerabilities, and network attacks. The end-to-end security that is achieved through use of the token at one side and a secure environment at the other side, such as a Host Security Module (HSM), completely eliminates the need to trust any software component, including the client operating system, or network. All information that is confidential is encrypted prior to its input to a computing station.

Furthermore, use of the hardware token eliminates the risk of phishing and spoofing attacks in which a user is tricked into connecting to a fraudulent website at which confidential information or credentials are stolen from a user. Through use of hardware token, even if an attacker receives the encrypted information intended to be received by a legitimate system, the attacker shall not be able to retrieve the original information nor shall the attacker be able to process a fraudulent transaction. In a scenario in which a one-time password token is used, the user can be tricked into entering a one-time password in a fraudulent web form in which the attacker immediately processes a fraudulent transaction on behalf of the user, using the one-time password supplied by the user.

The token is of small physical dimensions to facilitate its mobility, e.g., a carriage, by the user and connection to a computing station when needed. The hardware token is capable of storing multiple encryption keys, thereby eliminating the need to carry multiple tokens issued by multiple organizations. Additional cost savings are provided in an implementation that does not utilize a keypad or screen. Through appropriate selection of housings, the hardware token is tamper-resistant as confidential information is secured prior to application to a computing station. An attacker is unable to obtain the encryption key that is used by way of which to secure the confidential information.

In various implementations, the hardware token is utilized for authentication as well as, also, for e-signature applications. Additional security is achieved relative to conventional authentication tokens in which, in the case of using an authentication for online processing, transaction details could be tampered with, causing a fraudulent transaction to be processed instead of the one intended by the user. Using an e-signature token ensures that under no conditions shall a fraudulent transaction be accepted by a remote system. Additionally, use of the hardware token is advantageous for the reason that no additional software is required to be installed on the computing station. No additional toolbars, utilities, or drivers are required. The token is completely transparent to the computing station.

Presently-preferred embodiments of the invention and many of its improvements and advantages have been described with a degree of particularity. The description is of preferred examples of implementing the invention and the description of preferred examples is not necessarily intended to limit the scope of the invention. The scope of the invention is defined by the following claims.

What is claimed is:

1. Apparatus for facilitating entry of confidential information at a secured-communication-service station, said apparatus comprising:
a connector configured to form a connection with an input location of the secured communication service station;
a confidential information store configured to store confidential information; and
a converter configured to form secure data using the confidential information stored at said confidential information store, the secure data, once formed, provided to the secure communication service station by way of said connector.

2. The apparatus of claim 1 wherein said connector is configured to form a connection with an input port of a computer.

3. The apparatus of claim 2 wherein said connector is configured to form a connection with a USB, Universal Serial bus, port of the computer.

4. The apparatus of claim 2 wherein said connector is configured to form a connection with a serial port of the computer.

5. The apparatus of claim 1 wherein the confidential information stored at said confidential information store comprises an encryption key.

6. The apparatus of claim 1 wherein said converter is configured to combine input information with the confidential information to form the secure data.

7. The apparatus of claim 6 wherein said converter is configured to encrypt input information to form the secure data.

8. The apparatus of claim 1 wherein the confidential information store is configured to store a first encryption key and at least a second encryption key.

9. The apparatus of claim 8 wherein said converter is configured to form first encrypted data using the first encryption key and to form second encrypted data using the second encryption key.

10. The apparatus of claim 1 further comprising an input actuator configured to form input information responsive to input activation thereof.

11. The apparatus of claim 1 wherein the secured communication service station comprises a portable computer having an external keyboard and wherein said connector is configured to form a connection with a keyboard input port of the portable computer.

12. The apparatus of claim 11 wherein said converter is adapted to receive input information formed by actuation of the external keyboard and wherein said converter is configured to combine the confidential information with the input information to form the secure data.

13. A method for facilitating entry of confidential information at a secured-communication-service station, said method comprising:
storing confidential information external to the secured-communication-service station;
forming secure data external to the secured-communication-service station using the confidential information; and
providing the secure data to the secure-communication-service station.

14. The method of claim 13 further comprising generating input information external to the secured-communication-service station.

15. The method of claim 14 wherein said forming comprises combining the input information and the confidential information.

16. The method of claim 13 wherein said storing the confidential information comprises storing a first encryption key and at least a second encryption key.

17. The method of claim 16 wherein said forming the secure data further comprises selecting whether to form first secure data using the first encryption key and selecting whether to form second secure data using the second encryption key.

18. The method of claim 13 further comprising using the secure data provided to the secure-communication-service station pursuant to a secure communication service.

19. A method for facilitating secured data entry at a personal computer, said method comprising:
positioning an external hardware token in line between an input key and the personal computer;
encrypting input information input by way of the input key to the external hardware token from encrypted information; and
providing the encrypted information to the personal computer.

20. The method of claim 19 wherein said positioning comprises hot plugging the external hardware in line between the input key and the personal computer during operation of the personal computer.
